(19) United States
(12) Patent Application Publication
(10) Pub. No.: US 2016/0162718 A1
(43) Pub. Date: Jun. 9, 2016

(54) DYE RIBBON, IDENTIFYING DEVICE AND IDENTIFYING METHOD FOR IDENTIFYING PRODUCT INFORMATION OF THE DYE RIBBON

(71) Applicant: HiTi Digital, Inc., New Taipei City (TW)

(72) Inventors: Chu-Ming, LIU, New Taipei City (TW); Shiu-Sheng HSU, New Taipei City (TW); Tsung-Yuen CHEN, New Taipei City (TW)

(21) Appl. No.: 14/670,424

(22) Filed: Mar. 27, 2015

(30) Foreign Application Priority Data
Dec. 8, 2014 (TW) 103142616

(51) Int. Cl. G06K 7/10; G06K 19/06; B41M 5/382

(52) U.S. Cl. CPC G06K 7/10762; B41M 5/38228; B41M 5/38214; G06K 19/06028; G06K 7/10861; G06K 7/1096

(57) ABSTRACT

A dye ribbon, an identifying device and an identifying method for identifying product information of the dye ribbon are provided in the disclosure. The identifying method includes steps of moving the dye ribbon; emitting light to information interpretation pattern of the dye ribbon which is being moved; sensing the light transmitted through the information interpretation pattern, so as to generate a number of sensing signals corresponding to the information interpretation pattern; and identifying at least one set of product information of the dye ribbon in accordance with the sensing signals.

### RELATED APPLICATIONS

This application claims priority to Taiwan Application Serial Number 103142616, filed Dec. 8, 2014, which is herein incorporated by reference.

### BACKGROUND

1. Field of Disclosure

The present disclosure relates to a dye ribbon. More particularly, the present disclosure relates to a dye ribbon, an identifying device and an identifying method for identifying product information of the dye ribbon.

2. Description of Related Art

Generally, in a sublimation printing technology, after a dye ribbon installed in a ribbon cartridge is thermally treated and vaporized, respective dye regions of the dye ribbon are sequentially pressed on an article (such as a paper or a plastic card), so as to form a vivid color pattern on the article. The dye ribbons with different model numbers represents different dye region recipes or different sublimation treatment methods, which will greatly affect the color quality of the color pattern transferred and printed on the article.

A conventional method for identifying model types of dye ribbons in recent industries is to print a product serial number of the dye ribbon on an outer surface of the ribbon cartridge, or even to record the product serial number into a readable chip disposed on the outer surface of the ribbon cartridge. However, the conventional method of printing the product serial number of the dye ribbon on the ribbon cartridge or recording the product serial number into the readable chip not only increase the material cost, but also increase the overall mechanism complexity of the dye ribbon product.

Given in the above, the aforementioned inconvenience and shortcomings obviously exist and need to be improved. Therefore, how to effectively overcome the aforementioned inconvenience and shortcomings and how to increase the competitiveness of industries have be seriously concerned.

### SUMMARY

One aspect of this disclosure is to provide a dye ribbon, an identifying device and an identifying method for identifying product information of the dye ribbon to overcome the shortcomings and inconvenience of the prior art, that is, to provide a solution for quickly identifying the product information of the dye ribbon without increasing material cost and structure complexity of the whole product.

For achieving the aforementioned object, according to one or more embodiments of this disclosure, the identifying method for identifying product information of a dye ribbon includes the steps of moving a dye ribbon, wherein the dye ribbon is provided with at least one information interpretation pattern thereon; emitting light to the information interpretation pattern of the dye ribbon which is being moved by a light emitting unit; sensing the light transmitted through the information interpretation pattern by a light sensing unit, so as to generate a plurality of sensing signals corresponding to the information interpretation pattern; and correspondingly identifying at least one set of product information of the dye ribbon in accordance with the sensing signals.

According to one or more embodiments of this disclosure, the identifying method further includes the steps of correspondingly providing a driver program in accordance with the identified set of product information; and using the dye ribbon in accordance with the driver program.

According to one or more embodiments of this disclosure, the step of correspondingly identifying the at least one set of product information of the dye ribbon in accordance with the sensing signals further includes correspondingly identifying a print-starting point of the dye ribbon in accordance with the sensing signals.

According to one or more embodiments of this disclosure, when the sensing signals respectively are binary codes, the step of correspondingly identifying the at least one set of product information of the dye ribbon in accordance with the sensing signals further includes obtaining information matching a permutation combination of the binary codes as the at least one set of product information of the dye ribbon from a look-up table.

According to one or more embodiments of this disclosure, the at least one set of product information of the dye ribbon includes plural sets of production information, and a portion of the sensing signals is identified as one of the sets of product information of the dye ribbon, and another portion of the sensing signals is identified as another of the sets of product information of the dye ribbon.

According to one or more embodiments of this disclosure, the identifying method further includes the steps of emitting another light to another information interpretation pattern by another light emitting unit; sensing the another light transmitted through the another information interpretation pattern by another light sensing unit, so as to generate a plurality of other sensing signals corresponding to the another information interpretation pattern. The step of correspondingly identifying the at least one set of product information of the dye ribbon in accordance with the sensing signals further includes obtaining information matching a permutation combination of the sensing signals and the another sensing signals combined together as the at least one set of product information of the dye ribbon from a look-up table.

According to one or more embodiments of this disclosure, the step of emitting the light to the information interpretation pattern of the dye ribbon which is being moved by the light emitting unit further includes the steps of emitting the light to a first position of the information interpretation pattern by the light emitting unit; further emitting another light to a second position of the information interpretation pattern by another light emitting unit while the light emitting unit emits the light to the first position of the information interpretation pattern, in which a width of the first position is different to a width of the second position.

According to one or more embodiments of this disclosure, the step of sensing the light transmitted through the information interpretation pattern by the light sensing unit further includes the steps of sensing the light transmitted through the first position of the information interpretation pattern by the light sensing unit, so as to generate the sensing signals corresponding to the first position of the information interpretation pattern; sensing the another light transmitted through the second position of the information interpretation pattern by another light-sensing element; and obtaining information matching a permutation combination of the sensing signals and the another sensing signals combined together as the at least one set of product information of the dye ribbon from a look-up table.

According to one or more embodiments of this disclosure, at least two of light-absorbed barcode stripes of the information interpretation pattern are different in width, and the step of sensing the light transmitted through the information interpretation pattern by the light sensing unit further includes respectively obtaining the widths of the light-absorbed barcode stripes by motor drive signals or encoder feedback signals, so as to generate the sensing signals corresponding to the information interpretation pattern.

According to one or more embodiments of this disclosure, the at least one set of product information of the dye ribbon is selected from a group consisting of information of dye ribbon type, information of dye formulation type, information of program version type, information of manufactory type and manufactory manufacturing equipment type.

Another aspect of this disclosure is to provide an identifying device for identifying product information of a dye ribbon. According to one or more embodiments of this disclosure, the identifying device for identifying product information of a dye ribbon includes a ribbon transmission unit, at least one light emitting unit, at least one light sensing unit and a processing unit. The ribbon transmission unit drives a dye ribbon. The light emitting unit is disposed′ on one side of the dye ribbon. The light sensing unit is disposed on one side of the dye ribbon. The processing unit is electrically connected to the ribbon transmission unit, the light emitting unit and the light sensing unit. Therefore, when at least one information interpretation pattern of the dye ribbon passes through the light emitting unit, the light emitting unit emits light to the information interpretation pattern and the light sensing unit senses the light transmitted through the information interpretation pattern, so as to generate a plurality of sensing signals corresponding to the information interpretation pattern, and the processing unit correspondingly identifies at least one set of product information of the dye ribbon in accordance with the sensing signals.

According to one or more embodiments of this disclosure, the light emitting unit and the light sensing unit are respectively disposed at two opposite sides of the dye ribbon.

According to one or more embodiments of this disclosure, the light emitting unit and the light sensing unit are respectively disposed at the same side of the dye ribbon.

Another aspect of this disclosure is to provide a dye ribbon. According to one or more embodiments of this disclosure, the dye ribbon includes a ribbon rotation shaft and a ribbon body installed on the ribbon rotation shaft in a scrollable way. The ribbon body includes a base layer, a plurality of dye groups and at least one information interpretation pattern. The base layer includes a first surface, a second surface being opposite to the first surface, and a plurality of transparent block areas sequentially arranged on the first surface of the base layer. Each of the dye groups has a plurality of transferring material panels which are different in colors and fill the transparent block areas. The information interpretation pattern is disposed on the base layer. Each information interpretation pattern represents one set of product information of the dye ribbon.

According to one or more embodiments of this disclosure, the information interpretation pattern is positioned on at least one of the first surface and the second surface of the base layer.

According to one or more embodiments of this disclosure, the information interpretation pattern is positioned on a border area of each of the transparent block areas.

According to one or more embodiments of this disclosure, the base layer comprises a plurality of spaced areas. Each of the spaced areas is defined on the first surface of the base layer and is disposed between any two of the transparent block areas which are neighboring mutually, wherein the information interpretation pattern is positioned on anyone of the spaced areas.

According to one or more embodiments of this disclosure, the information interpretation pattern is positioned in the first one of the spaced areas of each of the dye groups.

According to one or more embodiments of this disclosure, the information interpretation pattern is a bar code pattern or a geometric pattern having different widths.

According to one or more embodiments of this disclosure, the bar code pattern comprises a plurality of light-absorbed barcode stripes, the light-absorbed barcode stripes are arranged abreast at intervals, and at least two of light-absorbed barcode stripes are different in width.

Therefore, since the version of the dye ribbon will be continually renewed frequently due to different dye formulations or different usages of the dye ribbon, with the design of the dye ribbon, the identifying device and the identifying method for identifying product information of the dye ribbon of the embodiment of this disclosure, before using the dye ribbon, or even using each of the transferring material panels of the dye ribbon, the product information of the dye ribbon can be quickly identified, so as to properly execute the corresponding jobs. For example, the dye ribbon is used according to the driver program in accordance with the corresponding type of the dye ribbon, so as to provide the optimized quality of transfer printing or to provide users with more detailed product information of the dye ribbon.

It is to be understood that both the foregoing general description and the following detailed description are by examples, and are intended to provide further explanation of the disclosure as claimed.

### BRIEF DESCRIPTION OF THE DRAWINGS

The disclosure may be more fully understood by reading the following detailed description of the embodiment, with reference made to the accompanying drawings as follows.

FIG. 1 is a flow chart of an identifying method for identifying product information of a dye ribbon according to an embodiment of the disclosure;

FIG. 2 is a simplified schematic view of an identifying device for identifying product information of a dye ribbon according to another embodiment of the disclosure;

FIG. 3 is a simplified schematic view of an identifying device for identifying product information of a dye ribbon of FIG. 2;

FIG. 4A is a front view of a dye ribbon of FIG. 3;

FIG. 4B is an enlarged view of a partial area M of FIG. 4A;

FIG. 5A is a simplified schematic view of an identifying device for identifying product information of a dye ribbon according to another embodiment of the disclosure;

FIG. 5B is a simplified top view of an identifying device for identifying product information of a dye ribbon according to another embodiment of the disclosure;

FIG. 6 is a side view of a dye ribbon according to another embodiment of the disclosure; and

FIG. 7 is a front view of a dye ribbon according to another embodiment of the disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the disclosure.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

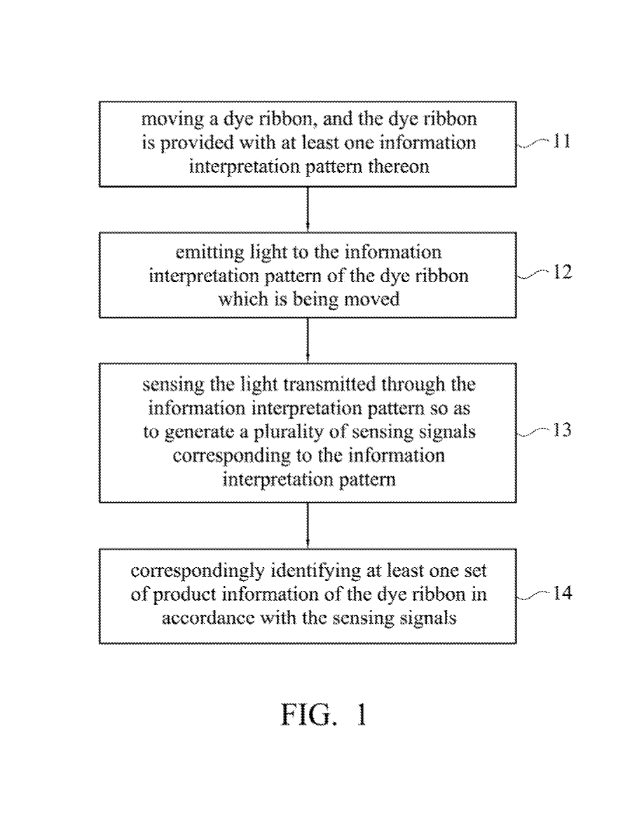

FIG. 1 is a flow chart of an identifying method for identifying product information of a dye ribbon according to an embodiment of the disclosure. As shown in FIG. 1, the identifying method for identifying product information of the dye ribbon includes the following steps 11 to 14. The step 11 is performed for moving a dye ribbon, and the dye ribbon is provided with at least one information interpretation pattern thereon. The step 12 is performed for emitting light to the information interpretation pattern of the dye ribbon which is being moved. The step 13 is performed for sensing the light transmitted through the information interpretation pattern, so as to generate a plurality of sensing signals corresponding to the information interpretation pattern. The step 14 is performed for correspondingly identifying at least one set of product information of the dye ribbon in accordance with the sensing signals.

Therefore, the user can get the related product information of the dye ribbon without needing to physically read a product serial number of the dye ribbon by his or her naked eyes. By the identifying method of the embodiment for quickly identifying product information of the dye ribbon, a device can properly execute the subsequent job corresponding to the dye ribbon based on the corresponding type of the dye ribbon. Thus, in the identifying method of the embodiment, the product serial number of the dye ribbon is not needed to be printed on the outer surface of the ribbon cartridge or to be recorded into a readable chip of the ribbon cartridge in the traditional method for identifying product information of the dye ribbon. Thus, not only the material cost can be decreased, but also the overall mechanism complexity of the dye ribbon product can be simplified.

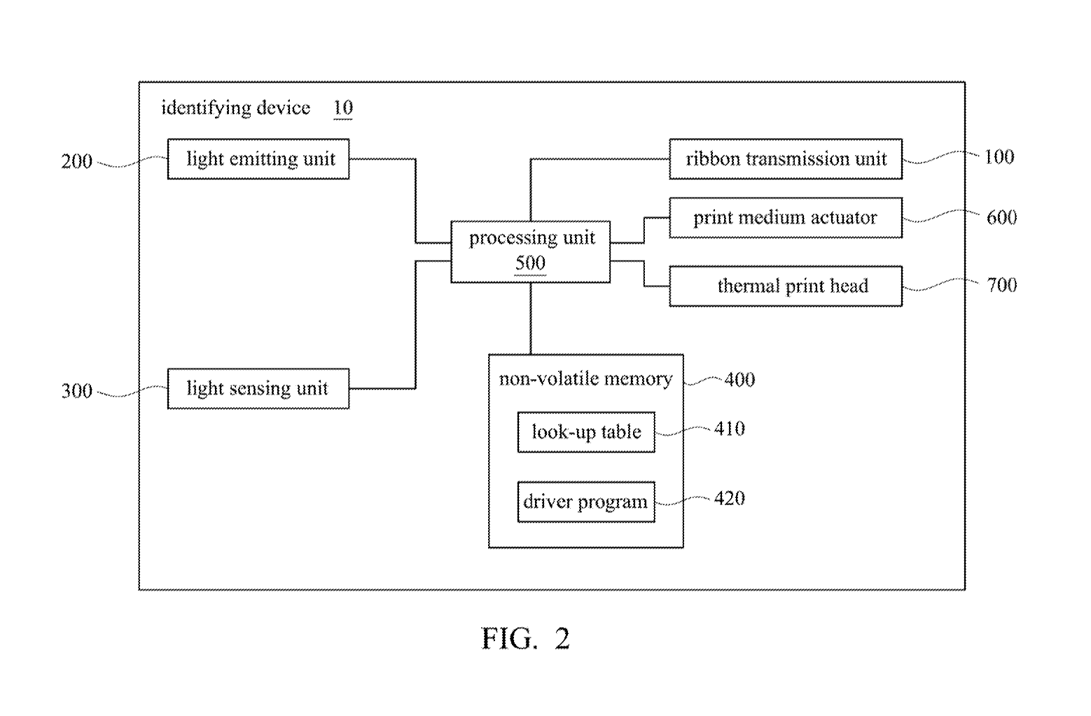

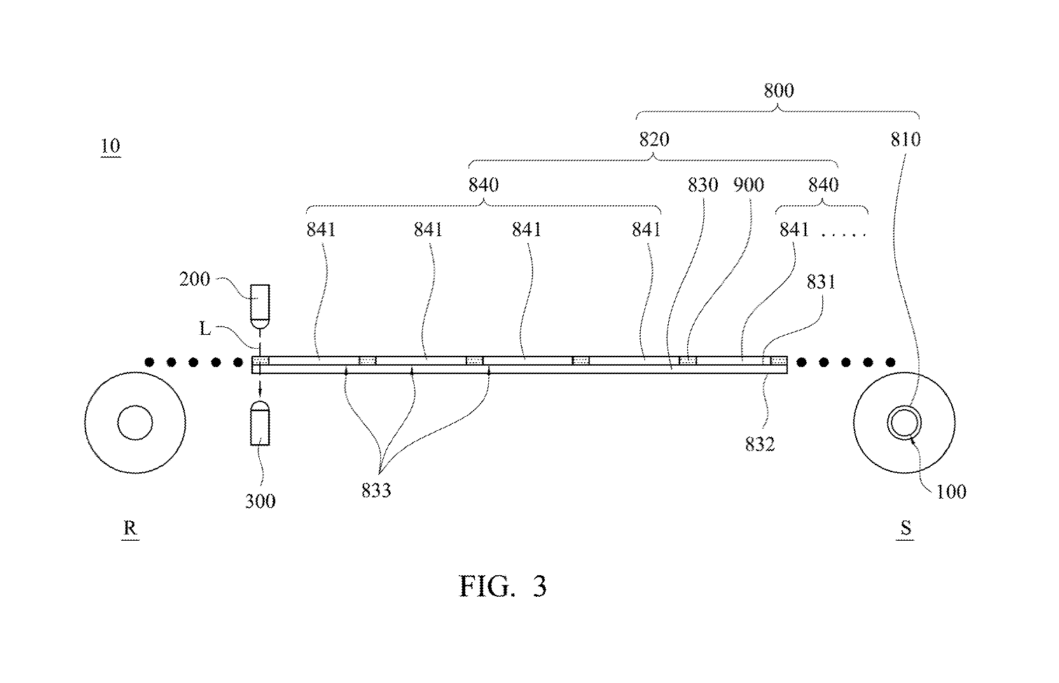

Reference is now made to FIG. 2 and FIG. 3. FIG. 2 is a simplified schematic view of an identifying device 10 for identifying product information of a dye ribbon according to another embodiment of the disclosure, and FIG. 3 is a simplified schematic view of an identifying device 10 for identifying product information of a dye ribbon of FIG. 2. In FIG. 2 and FIG. 3, a dye ribbon 800 includes a ribbon rotation shaft 810 and a ribbon body 820 wound around a ribbon rotation shaft 810 in a scrollable way. The ribbon body 820 includes a base layer 830, a plurality of dye groups 840 and at least one information interpretation pattern 900. Each of the dye groups 820 has a plurality of transferring material panels 841. The transferring material panels 841 are different in colors, and are respectively arranged abreast. The information interpretation pattern 900 is formed on the ribbon body 820 with an ink roller, for example. It is noted that, as long as the information interpretation pattern 900 can be identified as the set of product information of the dye ribbon, the information interpretation pattern 900 is not limited to being located on one of the transferring material layers only or on every transferring material panel; or to being located on an area between any two of the transferring material layers. The disclosure is not limited to the type of the product information of the dye ribbon. The product information of the dye ribbon, for example, can be specified as a dye ribbon type, a dye formulation type, a program version type, a manufactory type and a manufacturing equipment type etc.

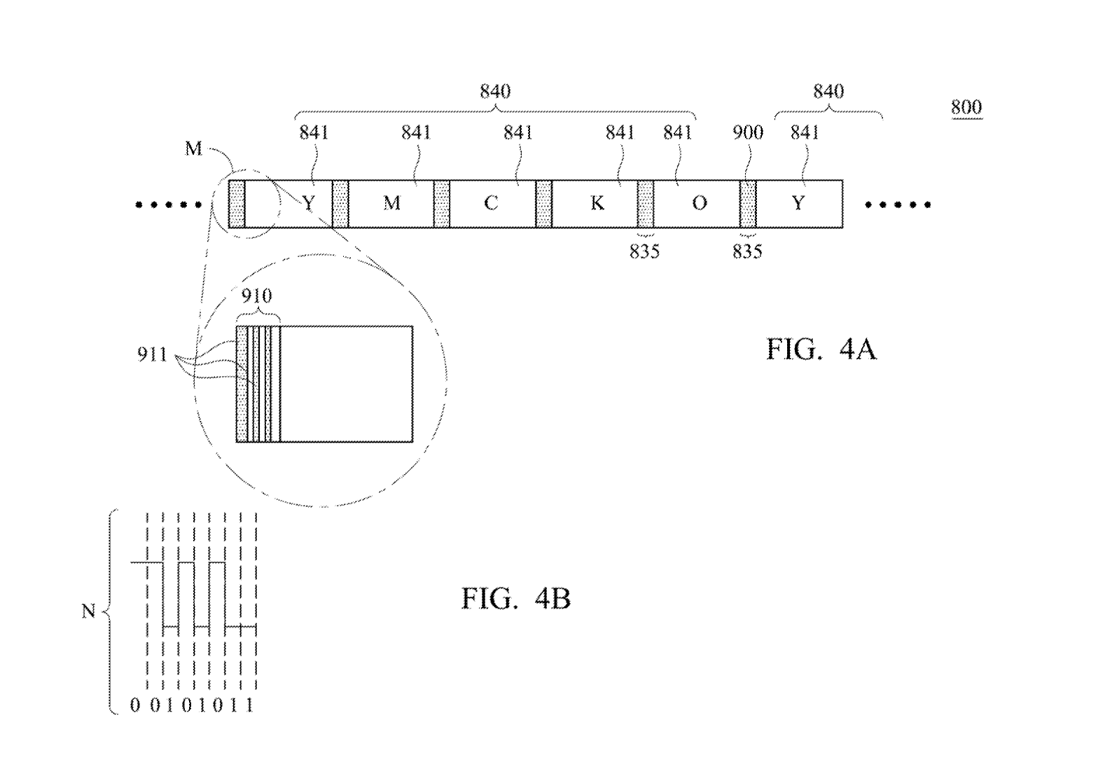

As shown in FIG. 3, the base layer 830 includes a first surface 831, a second surface 832 opposite to the first surface 831, and a plurality of transparent block areas 833 sequentially arranged on the first surface 831 of the base layer 830. The transferring material panels 841 respectively fill the transparent block areas 833. In the embodiment, however, the embodiment does not intend to limit the disclosure, the transferring material panels 841 in order are a yellow dye panel (Y), a magenta dye panel (M), a cyan dye panel (C), a mono dye panel (K) and an overcoat dye panel (O), and then the acronym YMCKO (FIG. 4A). The mono dye panel (K) can be black, gold, sliver or any other color without level change. The information interpretation pattern is disposed on the base layer. Each information interpretation pattern represents one of the product information of the dye ribbon. In other embodiments, the transferring material panels in order can be a yellow dye panel, a magenta dye panel, a cyan dye panel and a overcoat dye panel (O), and then the acronym YMCO.

FIG. 4A is a front view of the dye ribbon 800 of FIG. 3. As shown in FIG. 4A, in the embodiment, the base layer 830 includes a plurality of spaced areas 835. Each of the spaced areas 835 is defined on the first surface 831 of the base layer 830 and is formed between any two adjacent transparent block areas 833. The information interpretation pattern 900 is positioned in any one of the spaced areas 835. Therefore, when the dye ribbon 800 is manufactured, the information interpretation pattern 900 and the transferring material panels 841 can be formed simultaneously on the first surface 831 of the base layer 830 in the same process, and thus extra time and cost can be saved when the information interpretation pattern 900 is formed on the base layer 830.

In the embodiment, as shown in FIG. 2 and FIG. 3, the identifying device 10 includes a ribbon transmission unit 100, at least one light emitting unit 200, at least one light sensing unit 300 and a processing unit 500. The processing unit 500 is electrically connected to the ribbon transmission unit 100, and the light emitting unit 200 and the light sensing unit 300. When a dye ribbon 800 is loaded in the identifying device 10, the ribbon transmission unit 100 drives and moves the dye ribbon 800. In the embodiment, however, the embodiment does not intend to limit the disclosure, and the ribbon transmission unit 100 includes a ribbon supply S and a ribbon take-up R. The ribbon supply S and the ribbon take-up R mutually transport the dye ribbon 800. For example, both of the ribbon supply S and the ribbon take-up R are in a form of rolls or wheels, so as to supply and take-up the dye ribbon 800 for exposing a portion of the dye ribbon 800 between the ribbon supply S and the ribbon take-up R with a roll-to-roll method. The light emitting unit 200 is disposed on one side of the dye ribbon 800, for sequentially emitting light with a predetermined color to each area of the moving dye ribbon 800. The light sensing unit 300 is disposed on another side of the dye ribbon 800 opposite to the light emitting unit 200, for sequentially sensing the light transmitted through each area of the moving dye ribbon 800 so that a plurality of sensing signals (e.g., voltage level) corresponding to respective areas of the moving dye ribbon 800 are generated. Briefly speaking, the transmittance of the light of the light emitting unit 200 into the information interpretation pattern 900 and the transmittance of the light of the light emitting unit 200 into other areas of the moving dye ribbon 800 are different. Therefore, when the information interpretation pattern 900 and other areas of the moving dye ribbon 800 in order respectively passing through a space between the light emitting unit 200 and the light sensing unit 300, the light sensing unit 300 then generates different light intensity signals by receiving the light transmitted through the moving dye ribbon 800, and the light intensity signals are respectively processed′ to be transformed into the aforementioned sensing signals.

Therefore, when the information interpretation pattern 900 of the dye ribbon 800 moves through a space between the light emitting unit 200 and the light sensing unit 300, the light emitting unit 200 emits light L to the information interpretation pattern 900 and the light sensing unit 300 senses the light L transmitted through the information interpretation pattern 900, so as to generate a plurality of sensing signals corresponding to the information interpretation pattern 900. The processing unit 500 correspondingly identifies the product information of the dye ribbon 800 in accordance with the sensing signals generated from the light sensing unit 300 at this moment. On the other hand, when another area of the dye ribbon 800 moves through the space between the light emitting unit 200 and the light sensing unit 300, the processing unit 500 is unable to identifies the product information of the dye ribbon 800 in accordance with the sensing signals generated from the light sensing unit 300 at this moment.

In this embodiment, the identifying device 10 is a dye sublimation printer, and the identifying device 10 also includes a non-volatile memory 400, a print medium actuator 600 and a thermal print head 700. The non-volatile memory 400, for example, is an electrically erasable programmable read-only memory (EEPROM), and non-volatile memory 400 is electrically connected to the processing unit 500. The non-volatile memory 400 stores one or more look-up tables 410 or one or more driver programs 420. The print medium actuator 600 is electrically connected to the processing unit 500, and the print medium actuator 600 is used for stably moving a print medium (e.g., paper sheet or plastic card not shown in figures). The thermal print head 700 is electrically connected to the processing unit 500, and is positioned on a traveling route of the dye ribbon 800 above the print medium, and is instructed by the processing unit 500 to heat the dye ribbon 800 and transfer the transferring material panels 841 of the dye ribbon 800 on the print medium for forming one or more pictures thereon.

Therefore, when the dye ribbon 800 is used, or even before each of the transferring material panels 841 is heated by the thermal print head 700, the processing unit 500 correspondingly provides a driver program 420 in accordance with the identified product information, such as of the specified dye ribbon type or the dye formulation type of the specified transferring material panel, so that the dye ribbon 800 can be used properly in accordance with the corresponding driver program, so as to provide the optimized quality of transfer printing; or to provide users with more detailed product information of the dye ribbon.

For instance, the specified driver program 420 can instruct the thermal print head 700 to heat the corresponding transferring material panel 841 of the dye ribbon 800 with a specified heating method in accordance with the information of the dye formulation type of the corresponding transferring material panel 841, so that the optimized quality of transfer printing can be provided, or more detailed product information of the dye ribbon can be provided. However, the disclosure is not limited to the features described above, and the identifying device does not have to be the dye sublimation printer. In other embodiments, the identifying device also can be a detecting device. The detecting device having no print medium actuator and thermal print head installed therein is provided for reading a product traceability of the dye ribbon, so that the user can quickly find out a product traceability (such as the manufactory type, the manufacturing equipment type, the agent type or the sale area type or alike) of the dye ribbon.

FIG. 4B is an enlarged view of a partial area M of FIG. 4A. As shown in FIG. 4A and FIG. 4B, in this embodiment, however, the embodiment does not intend to limit the disclosure, the information interpretation pattern 900 is arranged on the dye ribbon 800, and the information interpretation pattern 900, for example, can be a barcode pattern 910 including a plurality of light-absorbed (e.g., dark color) barcode stripes 911. These light-absorbed barcode stripes 911, such as black color barcodes, are arranged abreast at intervals, and these light-absorbed barcode stripes 911 are the same in width. Therefore, by using the frequency of the light sensing unit 300 sensing the light coming through the barcode pattern 910 the light sensing unit 300 can generate a plurality of binary codes N corresponding to the information interpretation pattern 900. The processing unit 500 bases on a permutation combination of the binary codes N to obtain information matching the permutation combination of the binary codes N as the product information of the dye ribbon 800 from a look-up table 410.

However, the disclosure is not limited to the features described above, and these light-absorbed barcode stripes do not have to be the same in width. In other embodiments, when at least two of light-absorbed barcode stripes are different in width, the widths of the light-absorbed barcode stripes can be respectively obtained by using motor drive signals or encoder feedback signals, so as to generate the sensing signals corresponding to the information interpretation pattern.

In one example, when the ribbon transmission unit includes a step motor, the processing unit can obtain the widths (such as gap widths between the dotted lines shown in FIG. 4B) of the light-absorbed barcode stripes 911 according to the motor drive signals of the stepper motor, and the processing unit can generate the aforementioned binary codes N according to the widths of the light-absorbed barcode stripes 911. For another example, when the ribbon transmission unit includes a DC motor, the processing unit can obtain the widths (such as the gap widths between the dotted lines shown in FIG. 4B) of the light-absorbed barcode stripes 911 according to the encoder feedback signals of an encoder being suitable to the DC motor, and generate the aforementioned binary codes N according to the widths of the light-absorbed barcode stripes 911.

Furthermore, the aforementioned binary codes N of the barcode pattern are not limited to the number of the light-absorbed barcode stripes and the number of the types of the product information. For example, the whole binary codes N of the barcode pattern can represent a single type of the product information only; or after the binary codes N of the barcode pattern is divided into, such as two sections, one part of the sensing signals is identified as one kind of the product information of the dye ribbon, and the other part of the sensing signals is identified as another kind of the product information of the dye ribbon. For example, in FIG. 4B, when the binary codes N is shown as “00101011”, the former part of the binary codes N shown as “0010” can be identified as the product serial number of the dye ribbon, the latter part of the binary codes N shown as “1011” can be identified as the dye formulation type of the transferring material panels.

However, the disclosure is not limited to the features described above, and in other embodiments, other than the product information of the dye ribbon, another part of the binary codes also can be further identified as a print-starting point of the dye ribbon. For example, the information interpretation pattern is positioned in a first one of the spaced areas of each of the dye groups. The print-starting point of the dye ribbon can be a print-starting point of each of the dye groups or a print-starting point of a specified transferring material panel of each dye group. If the print-starting point of the dye ribbon is a print-starting point of each of the dye groups, the information interpretation pattern is in the first one of the spaced areas of each of the dye groups. If the print-starting point of the dye ribbon is a print-starting point of a specified transferring material panel of each dye groups, the information interpretation pattern is in one of the spaced areas being in front of the specified transferring material panel of each dye group.

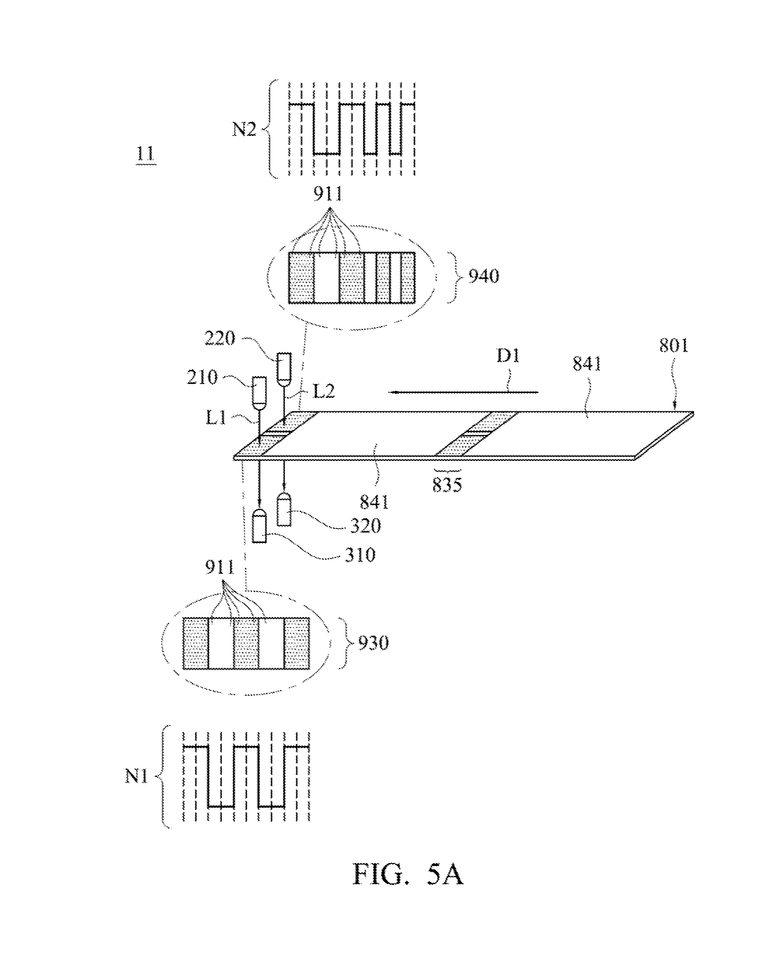

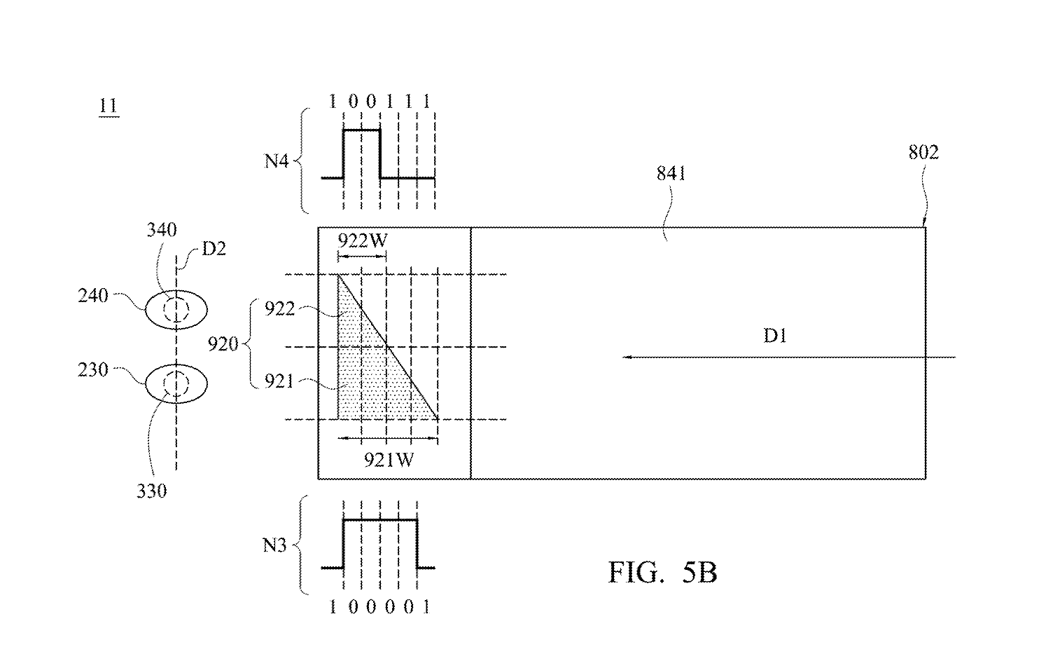

FIG. 5A is a simplified schematic view of an identifying device 11 for identifying product information of a dye ribbon 801 according to another embodiment of the disclosure. As shown in FIG. 5A, one of the main differences between this embodiment and the aforementioned embodiment is that: a first information interpretation pattern 930 and a second information interpretation pattern 940 are respectively provided on two symmetrical positions of a surface of the dye ribbon 801. The identifying device 11 includes a first light emitting unit 210, a first light sensing unit 310, a second light emitting unit 220 and a second light sensing unit 320. Thus, when the first information interpretation pattern 930 is moved through a space between the first light emitting unit 210 and the first light sensing unit 310, and the second information interpretation pattern 940 is moved through a space between the second light emitting unit 220 and the second light sensing unit 320, the first light emitting unit 210 emits light L1 to the first information interpretation pattern 930, and at the same moment, the second light emitting unit 220 emits light L2 to the second information interpretation pattern 940 as well. Next, the first light sensing unit 310 senses the light L1 and generates a plurality of first sensing signals (i.e., binary codes N1) corresponding to the first information interpretation pattern 930, and at the same moment, the second light sensing unit 320 senses the light L2 and generates a plurality of second sensing signals (i.e., binary codes N2) corresponding to the second information interpretation pattern 940. Thus, the processing unit 500 bases on a permutation combination of the first sensing signals (i.e., binary codes N1) combined with the second sensing signals (i.e., binary codes N2) to obtain information matching the permutation combination as the product information of the dye ribbon 801 from a look-up table 410.

Therefore, by configuring more information interpretation patterns, the light sensing units with corresponding quantity with the information interpretation patterns may generate different permutation and combinations of the sensing signals, so as to increase the number of the product information for identification, and increase the number of the product information being stored in the dye ribbon.

However, the disclosure is not limited to the number and the arrangement of the information interpretation patterns, one person with ordinary skill in the art may flexibly modify the number and the arrangement of the information interpretation patterns according to demands or limitations.

FIG. 5B is a simplified top view of an identifying device 11 for identifying product information of a dye ribbon 802 according to another embodiment of the disclosure. As shown in FIG. 5B, one of the main differences between this embodiment and the aforementioned embodiment is that: the information interpretation pattern, for example, is a geometric pattern 920 having different widths along a longitudinal direction. The identifying device 11 includes a third light emitting unit 230, a third light sensing unit 330, a fourth light emitting unit 240 and a fourth light sensing unit 340.

Thus, when the geometric pattern 920 is moved through a space between the third light emitting unit 230 and the third light sensing unit 330, and a space between the fourth light emitting unit 240 and the fourth light sensing unit 340 at the same time, the third light emitting unit 230 emits light to a first position 921 of the geometric pattern 920, and at the same moment, the fourth light emitting unit 240 emits light to a second position 922 of the geometric pattern 920 as well. A width 921W of the first position 921 of the geometric pattern 920 is different from a width 922W of the second position 922 of the geometric pattern 920. Next, while the third light sensing unit 330 generates third sensing signals (i.e., binary codes N3) corresponding to the first position 921 thereof, the fourth light sensing unit 340 generates fourth sensing signals (i.e., binary codes N4) corresponding to the second position 922 thereof at the same moment. Finally, the processing unit 500 bases on a permutation combination of the third sensing signals (i.e., binary codes N3) combined with the fourth sensing signals (i.e., binary codes N4) to obtain information matching the permutation combination as the product information of the dye ribbon 802 from a look-up table 410.

Although the geometric pattern 920 of the FIG. 5B is triangular, yet the disclosure is not limited to the features described above, one person with ordinary skill in the art may flexibly modify the number and the shape of the geometric pattern 920 according to demands or limitations.

Furthermore, as shown in FIG. 5A and FIG. 5B, when the ribbon transmission unit 100 moves the dye ribbon 802 in a direction (e.g., virtual line D1), the third light emitting unit 230 and the fourth light emitting unit 240 are positioned on a virtual line D2 perpendicular to the virtual line D1. However, the disclosure is not limited to the features described above, the third light emitting unit 230 and the fourth light emitting unit 240 also can be positioned on another virtual line which is not perpendicular to the virtual line D1.

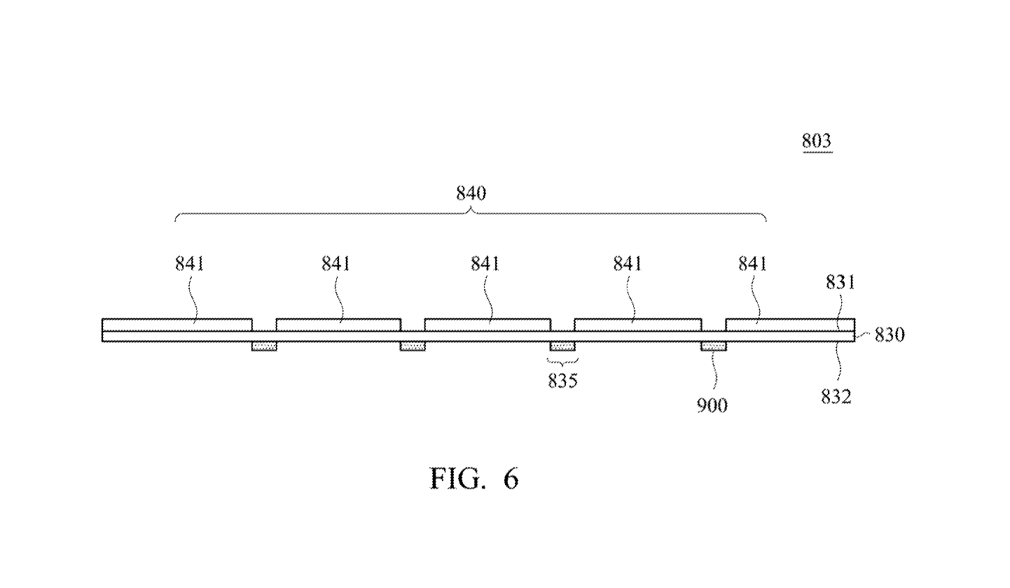

FIG. 6 is a side view of a dye ribbon 803 according to another embodiment of the disclosure. As shown in FIG. 6, one of the main differences between this embodiment and the aforementioned embodiment is that: the information interpretation patterns 900 are located on the second surface 832 of the base layer 830, rather than on the first surface 831 on which the transferring material panels 841 is disposed. Each of the information interpretation patterns 900 is disposed between any two of the transferring material panels 841. Therefore, since the information interpretation patterns 900 are located on the second surface 832 of the base layer 830, no matter whether the information interpretation patterns 900 is disposed between any two of the transferring material panels 841, the information interpretation patterns 900 will not affect the transfer of the transferring material panels 841, so as to avoid degrading the color quality of transfer printing.

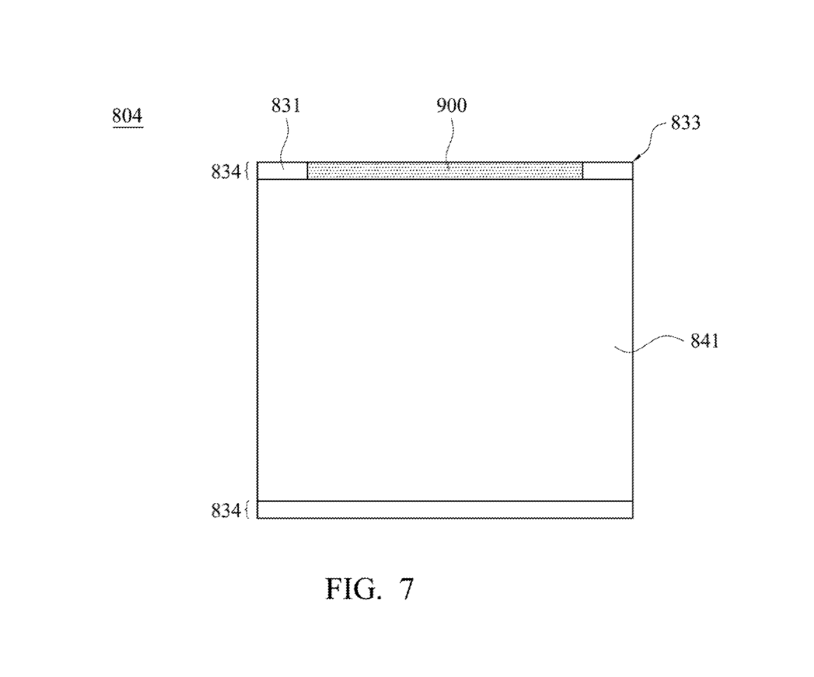

FIG. 7 is a front view of a dye ribbon according to another embodiment of the disclosure. As shown in FIG. 7, one of the main differences between this embodiment and the aforementioned embodiment is that: the information interpretation patterns 900 are located on the first surface 831 of the base layer 830, and arranged in any one of the transparent block areas 833. Preferably, the information interpretation patterns 900 is positioned on a border area 834 of each of the transparent block areas 833. Therefore, since the transferring material panel 841 disposed in the transparent block area 833 does not contact the border area 834 of the transparent block area 833, the information interpretation patterns 900 also will not affect the transfer of the transferring material panels 841, so as to avoid degrading the color quality of transfer printing.

It is noted that, in those embodiments, the light emitting units are not limited to a visible light emitting unit or a non-visible light emitting unit; the light sensing units are not limited to an optical interrupter sensor or an optical reflective sensor; and the information interpretation patterns are not limited to visible painting material or non-visible material.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of the disclosure provided they fall within the scope of the following claims and their equivalents.

What is claimed is:

1. An identifying method for identifying product information of a dye ribbon, the identifying method comprising:
moving a dye ribbon, wherein the dye ribbon is provided with at least one information interpretation pattern thereon;
emitting light to the information interpretation pattern of the dye ribbon which is being moved by a light emitting unit;
sensing the light transmitted through the information interpretation pattern by a light sensing unit, so as to generate a plurality of sensing signals corresponding to the information interpretation pattern; and
correspondingly identifying at least one set of product information of the dye ribbon in accordance with the sensing signals.

2. The identifying method of claim 1, further comprising:
correspondingly providing a driver program in accordance with the identified set of product information; and
using the dye ribbon in accordance with the driver program.

3. The identifying method of claim 1, wherein the step of correspondingly identifying the at least one set of product information of the dye ribbon in accordance with the sensing signals further comprises:
correspondingly identifying a print-starting point of the dye ribbon in accordance with the sensing signals.

4. The identifying method of claim 1, wherein the sensing signals respectively are binary codes, and the step of correspondingly identifying the at least one set of product information of the dye ribbon in accordance with the sensing signals further comprises:
according to a permutation combination of the binary codes, obtaining information matching the permutation combination of the binary codes as the at least one set of product information of the dye ribbon from a look-up table.

5. The identifying method of claim 4, wherein the at least one set of product information of the dye ribbon comprises plural sets of production information, and a portion of the sensing signals is identified as one of the sets of product information of the dye ribbon, and another portion of the sensing signals is identified as another of the sets of product information of the dye ribbon.

6. The identifying method of claim 1, further comprising:
emitting another light to another information interpretation pattern by another light emitting unit;
sensing the another light transmitted through the another information interpretation pattern by another light sensing unit, so as to generate a plurality of other sensing signals corresponding to the another information interpretation pattern; and
the step of correspondingly identifying the at least one set of product information of the dye ribbon in accordance with the sensing signals further comprises:
according to a permutation combination of the sensing signals combined with the another sensing signals, obtaining information matching the permutation combination as the at least one set of product information of the dye ribbon from a look-up table.

7. The identifying method of claim 1, wherein the step of emitting the light to the information interpretation pattern of the dye ribbon which is being moved by the light emitting unit further comprises:
emitting the light to a first position of the information interpretation pattern by the light emitting unit; and
the identifying method further comprises:
further emitting another light to a second position of the information interpretation pattern by another light emitting unit while the light emitting unit emits the light to the first position of the information interpretation pattern, wherein a width of the first position is different to a width of the second position.

8. The identifying method of claim 7, wherein the step of sensing the light transmitted through the information interpretation pattern by the light sensing unit, so as to generate the sensing signals corresponding to the information interpretation pattern further comprises:
sensing the light transmitted through the first position of the information interpretation pattern by the light sensing unit, so as to generate the sensing signals corresponding to the first position of the information interpretation pattern; and
the identifying method further comprises:
sensing the another light transmitted through the second position of the information interpretation pattern by another light-sensing element; and
the step of correspondingly identifying the at least one set of product information of the dye ribbon in accordance with the sensing signals further comprises:
according to an permutation combination of the sensing signals combined with the another sensing signals, obtaining information matching the permutation combination as the at least one set of product information of the dye ribbon from a look-up table.

9. The identifying method of claim 1, wherein at least two of light-absorbed barcode stripes of the information interpretation pattern are different in width, and the step of sensing the light transmitted through the information interpretation pattern by the light sensing unit, so as to generate the sensing signals corresponding to the information interpretation pattern, further comprises:
respectively obtaining the widths of the light-absorbed barcode stripes by motor drive signals or encoder feedback signals, so as to generate the sensing signals corresponding to the information interpretation pattern.

10. The identifying method of claim 1, wherein the at least one set of product information of the dye ribbon is selected from a group consisting of a dye ribbon type, a dye formulation type, a program version type, a manufactory type and a manufacturing equipment type.

11. A dye ribbon comprising:
a ribbon rotation shaft; and
a ribbon body installed on the ribbon rotation shaft in a scrollable way, the ribbon body comprising:
a base layer comprising a first surface, a second surface opposite to the first surface, and a plurality of transparent block areas sequentially arranged on the first surface of the base layer;
a plurality of dye groups of which each has a plurality of transferring material panels which are different in colors and fill the transparent block areas; and
at least one information interpretation pattern disposed on the base layer, wherein each of the at least one information interpretation pattern represents one of the at least one set of product information of the dye ribbon.

12. The dye ribbon of claim 11, wherein the information interpretation pattern is positioned on at least one of the first surface and the second surface of the base layer.

13. The dye ribbon of claim 11, wherein the information interpretation pattern is positioned on a border area of each of the transparent block areas.

14. The dye ribbon of claim 11, wherein the base layer comprising:
a plurality of spaced areas each of which each is defined on the first surface of the base layer and is disposed between any two adjacent transparent block areas, wherein the information interpretation pattern is positioned inside any one of the spaced areas.

15. The dye ribbon of claim 14, wherein the information interpretation pattern is positioned in the first one of the spaced areas of each of the dye groups.

16. The dye ribbon of claim 11, wherein the information interpretation pattern is a bar code pattern or a geometric pattern having different widths.

17. The dye ribbon of claim 16, wherein the bar code pattern comprises a plurality of light-absorbed barcode stripes, and the light-absorbed barcode stripes are arranged abreast at intervals, and at least two of light-absorbed barcode stripes are different in width.

18. An identifying device for identifying product information of a dye ribbon, the identifying device comprising:
a ribbon transmission unit configured to drive a dye ribbon;
at least one light emitting unit disposed on one side of the dye ribbon;
at least one light sensing unit disposed on one side of the dye ribbon; and
a processing unit electrically connected to the ribbon transmission unit, the light emitting unit and the light sensing unit,
wherein, when at least one information interpretation pattern of the dye ribbon passes through the light emitting unit, the light emitting unit emits light to the information interpretation pattern, and the light sensing unit senses the light transmitted through the information interpretation pattern, so as to generate a plurality of sensing signals corresponding to the information interpretation pattern, and the processing unit correspondingly identifies at least one set of product information of the dye ribbon in accordance with the sensing signals.

19. The identifying device of claim 18, wherein the light emitting unit and the light sensing unit are respectively disposed at two opposite sides of the dye ribbon.

20. The identifying device of claim 18, wherein the light emitting unit and the light sensing unit are respectively disposed at the same side of the dye ribbon.
